(19) United States
(12) Patent Application Publication
(10) Pub. No.: US 2004/0242216 A1
(43) Pub. Date: Dec. 2, 2004

(54) Systems and methods for transferring data between mobile stations

(75) Inventor: Demetrios Boutsikakis, Dallas, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 10/452,709

(22) Filed: Jun. 2, 2003

(51) Int. Cl. H04M 3/00

(52) U.S. Cl. 455/418; 455/420

(57) ABSTRACT

The present invention provides systems and methods for transferring data between devices. The systems and methods include hardware and/or software located in the mobile stations. The systems and methods display a menu to the user that allows the user to select data for transfer, the method of transfer, the device to transfer the data to or from, and the specific model of the selected device. The systems and methods of the present invention, based on the options selected by the user, retrieve the selected data from one device, convert the data such that it is compatable with that of the other device, and transfers the data. Once received, the data is stored for use.

### BACKGROUND OF THE INVENTION

1. Field of the Invention

The present invention relates to transfer of data stored in one mobile station to one or more second mobile stations via a data link.

2. Description of Related Art

In recent years, there has been a marked increase in the number of features that are available on mobile stations, such as cell phones. This increase has been facilitated in part by the advancement in the electronics and battery packs used in the mobile stations. Further, as users have become more accustomed to the use of mobile stations, such as cell phones, users have requested the addition of features to the mobile stations to thereby increase their versatility.

For example, the first generation of cell phones typically included only features for placement and reception of phone calls. In later generations, features such as phone books were added that allowed a user to store various phone numbers. Nowadays, cell phones and other types of mobile stations include a wide variety of features that can be customized by the user. Cell phones now provide features such as to-do-lists, calendars, short message service (SMS), email, various ring tones, Internet access, wireless application protocol (WAP) book marks, etc. The phone book will include telephone numbers entered and saved by the user. The to-do-list and calendar will also be populated with information specific to the user. Similarly, email, email settings, Internet settings, ring tone, etc. may all be customized by the user. The cell phone may even include customized features that were purchased by the user, such as specialized ring tones.

This individualization of cell phone features is an important selling point. In fact, the various features provided by a particular mobile station, such as a cell phone, is a major factor considered by many end consumers when buying a new cell phone and/or selecting a service provider. Despite the advantages of user customization, however, there are also some disadvantages. Specifically, after a user has customized his or her cell phone, they are typically reluctant to trade in their old cell phone for a new phone. The user typically is left in a quandary as to whether they should purchase a new cell phone having enhanced features with the understanding that they will have to reprogram the new phone with their desired settings and information or forego the new features offered by a newer phone in order to maintain their current settings and information as provided in their currently customized phone.

In view of the above, systems have been created that allow for at least some limited transfer of customized information from one mobile station to another mobile station. For example, U.S. Pat. No. 5,062,132 to Yasuda et al. discloses a system that allows individually stored one touch phone numbers, (e.g., speed dial), to be transferred from a first handset to a second handset. The '132 Yasuda patent is related to wireless telephones having only limited features such as limited number storage and not cell phones that provide a wide variety of other features and settings. As such, the system of the '132 Yasuda patent does not address transfers of various types of information as is desired in cell phone applications. Further, it does not discuss transfer of data between phones having different data formats.

U.S. Pat. No. 6,041,229 to Turner describes a system for transferring information between different radiotelephones. The '229 Turner patent describes a system that uses an intermediary terminal between the two phone. The terminal includes the various logic and software for transferring information between the phones. The '229 Turner patent does not appear to disclose transmission of data directly between different phones and thus, may be seen as requiring use of the intermediary terminal.

U.S. Pat. No. 5,930,703 to Cairns also describes a system for transmitting data between different radiotelephones. However, the '703 Cairns patent discloses only transmission of a phone book from one phone to the other. It does not disclose transfer of other types of information between the phones.

In light of the above, systems and methods are needed that provide for transmission of data between two mobile stations without requiring an intermediate device. Further, systems and methods are needed for transmitting various types of data between mobile stations in addition to electronic phone books.

### BRIEF SUMMARY OF THE INVENTION

The present invention provides systems and methods that overcome the above-discussed, as well as many other disadvantages noted in the prior art. Specifically, the present invention provides systems and methods for transmitting data from one device to another, such as between two mobile stations. Specifically, the present invention provides a system for use in a device, such as a mobile station, comprising hardware and/or software. The hardware and/or software are configured to operate with the existing hardware and software of the device. The systems and methods are capable of retrieving various types of data stored in the device upon request by a user. The systems and methods of the present invention reformat the data, if needed, to be compatible with the device to which it is being transmitted. In these instances, software drivers are used to convert the data. In instances where data is not compatible because of a particular device model, the systems and methods will generate a data transfer error message. Further, the systems and methods use either existing data links, such as the RF circuit, IR circuit, or data connector, or a specialized data transfer circuit and connector for transmitting the data to either one or several devices. Complimentary logic and software is located on the devices to which the data is transmitted to properly receive and store the data.

In addition to providing hardware and/or software for retrieval and transmission of data, the logic and software also provides a user of the device a menu listing possible types of data that can be transmitted. The systems and methods of the present invention allow the user to select either portions or all of the data to be transmitted. Further, the menu provides a list of options for transmission of the data, such as via cable, IR, RF, etc. Finally, the menu includes a list of phone types that are compatible with the data selected. This menu requests the user to input the type of phone to which the user wishes to transmit the data. In some instances, this phone list may be lengthy, and therefore, the list may be shortened to only those phone models most commonly used. In instances, where a particular phone is not listed, the end customer may contact the service provider and have the phone and its associated driver downloaded into the cell phone. Further, frequent updates to the phone list and/or software drivers can be made by down loading the updates for a service provider or the manufacturer via wireless or direct connection.

Following these selections, the menu provided by the systems and methods of the present invention provides a selection for initiating the transmission of the information. During data transmission, the systems and methods of the present invention may provide an indication to the user that the transmission is in progress. The systems and methods may also provide an indication when transmission has been completed. The systems and methods may further generate a report at the end transmission and storage to both cell phones summarizing the data transfer, noting any errors, and noting any data that was not transferred successfully and the reasons why the data was not transferred and/or error codes.

Importantly, the systems and methods of the present invention provide a convenient way for a user to transmit either all or selected portions of information from one device to another. The hardware and/or software needed for the data transfer is housed in the device, and as such, an intermediary device is not required. If the data is compatible, software drivers are not required. However, if needed, they are either stored in the mobile station or can be down loaded from the service provider or manufacturer. Further, the systems and methods of the present invention provide a detailed download menu that allows the user to select which data is to be transferred, the type of data link, i.e., RF, IR, connector, and the type of device that the data is being transferred. Based on these various selections, the selected data is retrieved, formatted, and sent to the selected device (s).

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram of a mobile communications system according to one embodiment of the present invention including a mobile station and a Base Station/MSC/Interworking function (BMI) to which the mobile station is bidirectionally coupled through wireless RF links;

FIG. 2 is a schematic diagram of a mobile station according to one embodiment of the present invention;

FIGS. 3A-3C are illustrative views of data being transmitted between different types of devices;

FIG. 4 is an operation diagram illustrating a method for selecting and transferring data between devices according to one embodiment of the present invention;

FIG. 5 is an operation diagram illustrating a method for selecting and transmitting data between devices according to one embodiment of the present invention;

FIGS. 6A-6H are illustrations of various menus provided by the present invention to a user for selection of data and transmission options to transmit data between devices according to one embodiment of the present invention;

FIG. 7 is an operation diagram illustrating a method for selecting and receiving data from a device according to one embodiment of the present invention; and

FIGS. 8A-8H are illustrations of various menus provided by the present invention to a user for selection of data and reception options to receive data from a device according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

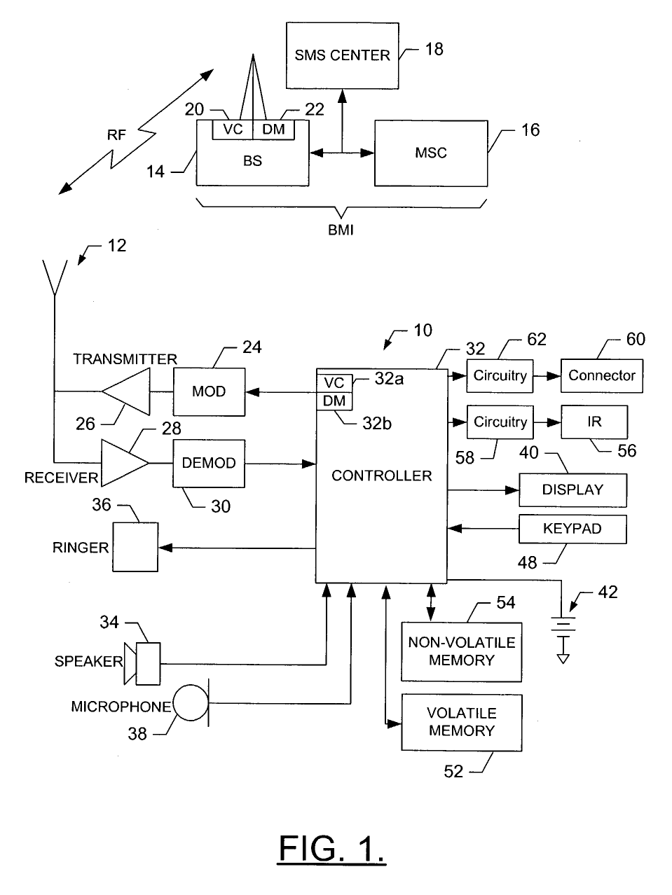

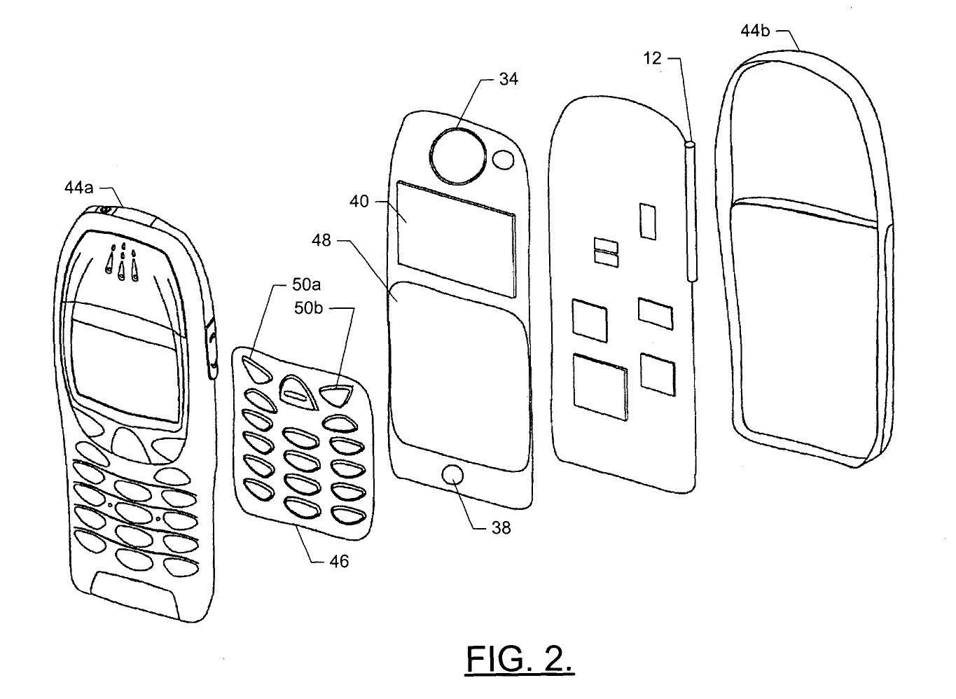

FIGS. 1 and 2 are respective schematic and perspective diagrams illustrating the generic features of a typical mobile station. In this particular instance, FIGS. 1 and 2 illustrate a cell phone, which is just one example of the different types of mobile stations in which the systems and methods of the present invention could be implemented. It must be understood that although the systems and methods of the present invention are described below in the context of a typical cell phone, that the present invention is not limited to either a particular type of cell phone or a particular type of mobile station. In a broad sense and as is contemplated herein, the systems and methods of the present can be used in any mobile station containing various features that may or may not be activated.

Referring to FIGS. 1 and 2, a typical mobile station 10 includes an antenna 12 for transmitting signals to and for receiving signals from a base site or base station (BS) 14. The base station is a part of a cellular network that includes a mobile switching center (MSC) 16, an SMS center 18, voice coder/decoders (vocoders) (VC) 20, data modems (DM) 22, and other units required to operate the network. The MSC is capable of routing calls and messages to and from the mobile station when the mobile station is making and receiving calls. The MSC also provides a connection to landline trunks when the mobile station is involved in a call. As indicated above, the cellular network may also be referred to as a Base Station/MSC/Interworking function (BMI) 14.

To communicate with the BMI 14, the mobile station 10 includes a modulator (MOD) 24, a transmitter 26, a receiver 28, a demodulator (DEMOD) 30, and a controller 32 that provide signals to and receive signals from the transmitter and receiver, respectively. These signals include signaling information in accordance with the communications standard of the applicable communication system, and also user speech and/or user generated data. For example, in the case of cell phones, the communications standard can comprise the Global System for Mobile (GSM) communications standard, the Code Division Multiple Access (CDMA) communications standard or any of their progeny and the like. The mobile station may also be configured to meet the wireless application protocol (WAP) specification. The controller 32 includes the circuitry required for implementing the audio and logic functions of the mobile station. The controller also includes the functionality to convolutionally encode and interleave message and data prior to modulation and transmission. The controller can additionally include an internal voice coder (VC) 32A, and may include an internal data modem (DM) 32B.

The mobile station 10 also comprises a user interface that includes a conventional earphone or speaker 34, a ringer 36, a conventional microphone 38, a display 40, and a user input interface, all of which are coupled to the controller 32. The mobile station also includes a battery 42 for powering the various circuits that are required to operate the mobile station.

To store data upon receipt from the various sources, the mobile station includes volatile memory 52, such as volatile Random Access Memory (RAM) including a cache area for the temporary storage of data. The mobile station can also include non-volatile memory 54, which can be embedded and/or may be removable such as a removable Subscriber Identification Module (SIM). The memories are used to store various pieces of information, such as settings for the various features of the mobile station, telephone numbers, calendar dates, emails, pictures, etc. The memories also include computer program products that control the operation of all or a portion of the controller 32 to thereby implement the present invention. The controller, which can include embedded cache memory, generates appropriate commands and controls the other component blocks of the mobile station.

In addition to the RF circuit, a typical mobile station may include additional circuitry for transmission and reception of data. For example, many mobile stations include an infrared transducer 56 and associated IR circuitry 58 connected to the controller 32 for transmission and reception of data via IR. Further, the mobile station may include a connector 60 and associated circuitry 62 connected to the controller 32 for transmitting data via a cable. For example, the circuitry and connector may be connected to the MBUS or FBUS of the mobile station. In addition or alternatively, the mobile station may include a connector and associated circuitry for communicating data using RS-232 protocol or universal serial bus (USB) protocol.

As illustrated in FIG. 2, the mobile station includes an external housing 44 that encapsulates the electronics of the mobile station. The mobile station also includes a user input membrane, such as a keypad membrane 46 that interfaces with a keypad 48, which collectively allow the mobile station to receive data from a user. The user membrane includes the conventional numeric (0-9) and related keys (#, *), and other keys used for operating the mobile station. In addition to the soft keys 50A and 50B, the other keys may include, for example, a SEND key, various menu scrolling keys and a PWR key. The display 40 can present any of a number of different displays, such as data, menus and/or listings. The display can also display areas for soft key functions that can be activated by pressing soft keys 50A and 50B located on a user input interface.

As stated, the mobile station includes software that is loaded in the memory of the mobile station and operated on by the controller 32. The software dictates the various operations of the mobile station. For example, the software, in conjunction with the hardware, controls the operation of the mobile station with regard to reception and transmission of phone calls. Further, and importantly, the software, in conjunction with the hardware, also provide various features to the user such as a phone book containing stored telephone numbers, calendar, calendars, short message service (SMS), e-mail, various ring tones, Internet access, wireless application protocol (WAP) book marks, etc.

With regard to FIG. 1, the present invention provides systems and methods that allow a user of a device such as a mobile station to transmit and/or receive data associated with the various features of the mobile station to or from different devices, such as mobile stations, networks, computers, etc. Specifically, the systems and methods of the present invention include software that is stored in the memories and operated on by the controller 32 of the mobile station. This software interacts with the existing hardware and software of the mobile station to provide a menu on the display 40 to the user. The display allows the user to select whether to transmit or receive data, the type of data, the means of transmission, the types of device to receive the data from or transmit the data to, etc. The systems and methods of the present invention receive input from the user via the key pad 48 or other user interface such as voice recognition circuitry. If the user has selected to transmit data, the systems and methods retrieve the selected data, convert it to a proper format, if needed, and transmit the data using either the RF, IR, or connector circuit of the mobile station to the mobile station(s) selected by the user. If the user has selected to receive data, the systems and methods may either transmit a message to the selected device requesting the selected data be transmitted, if required, or instead may await for data to be transmitted to the mobile station. Once received, the data is converted in to a proper format, if needed, and stored in the proper location. The systems and methods may further provide status information detailing the data transfer and any errors or incompatibilities that may have occurred.

Provided below is an illustrative description of the receive and transmit functions of the systems and methods of the present invention for transferring data between mobile stations. It is understood that these functions may be used in conjunction with one another or independently. For example, two users may wish to transfer data to each other. In this scenario, one user may use the transmit functions, while the other user will use the receive functions to perform data transfer. In some instances, these functions are used independent of each other. For example, a user may use the transmit functions to transmit data to another mobile station without the need for the receiving station to actively select to receive the data. In this instance, the data will be transmitted, received and stored by the receiving mobile station. Further, a user may use the receive functions to receive data from a device without requiring that the transmitting device initiate the data transfer. In this instance, after the user has selected the data to receive and the device to receive the data from, the systems and methods send a command to the device. Based on this command, the device retrieves and transmits the data to the mobile station, where it is received and stored.

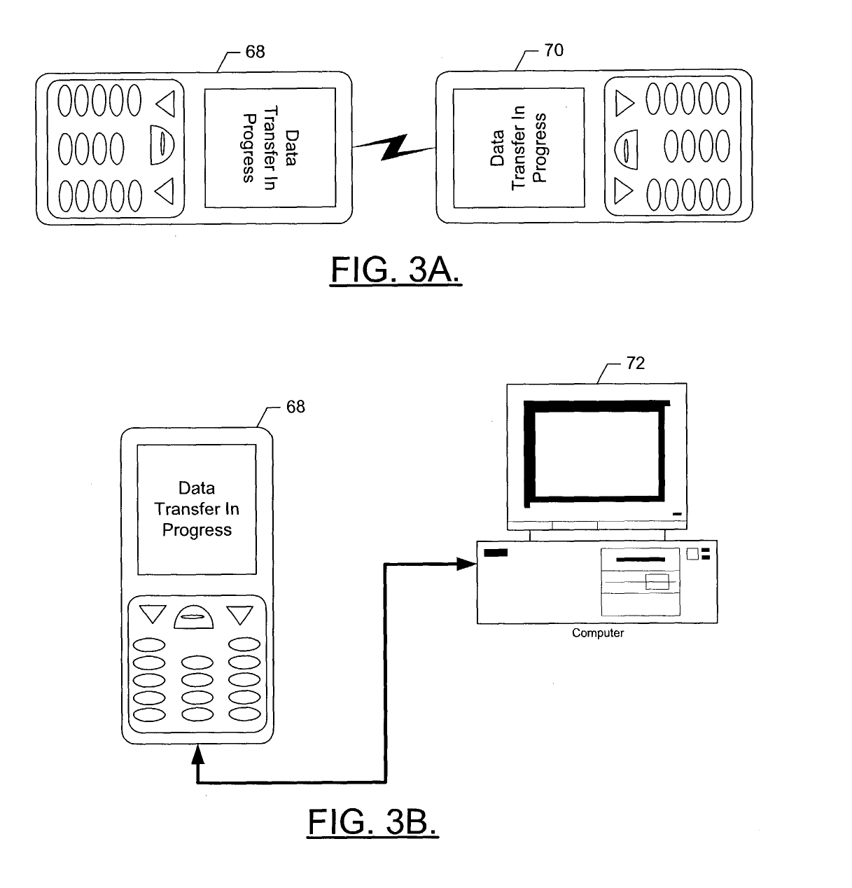

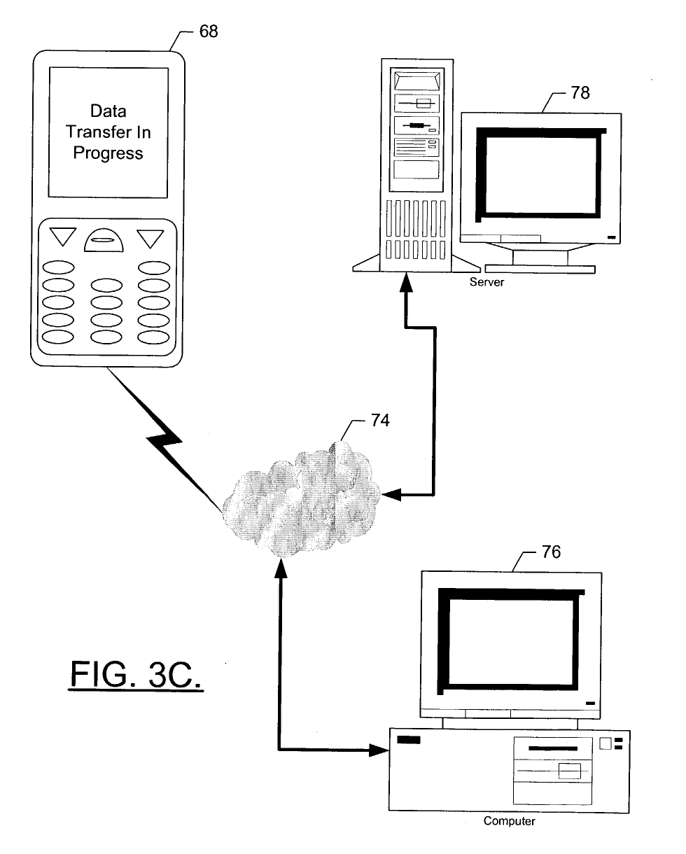

FIGS. 3A-3B illustrate several uses of the present invention. FIG. 3A illustrates use of the present invention to transmit data between two or more mobile stations, 68 and 70, such as cell phones. In this embodiment, data is typically transferred using IR ports associated with each mobile station. However, data could also be transmitted using the RF circuits of the mobile stations or via a cable connection between the mobile stations.

FIG. 3B illustrates data transmission between a mobile station 68 and a computer 72. In this embodiment data transmission is typically via a cable, but can be wireless such as RF or IR. Typically, software such as PC Suite is used on the computer to interface with the mobile station.

FIG. 3C illustrates data transmission between a mobile station 68 and a network 74 having at least one computer 76 and possibly a server 78. OTA or SyncML may be used for communication between the network and the mobile station over either a wireless or cable connection. For example, the system may use a WiFi connection for communication. It is understood that FIGS. 3A-3C are only examples of the many uses of the present invention. The concepts described below may be used for transmission of data between computers, networks, mobile stations, etc.

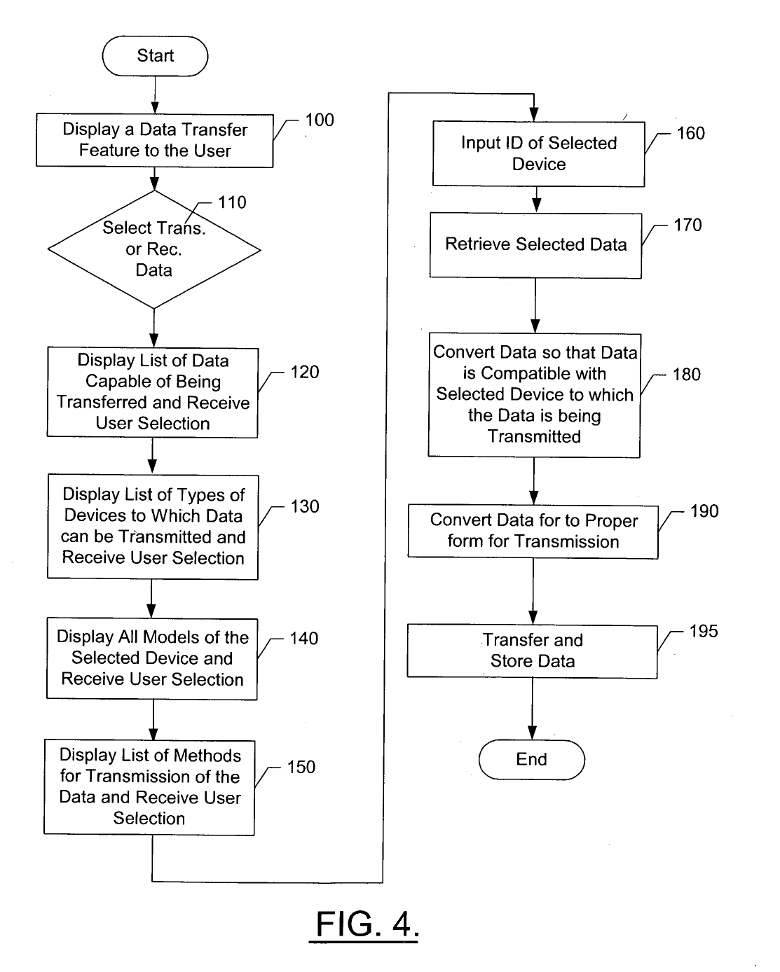

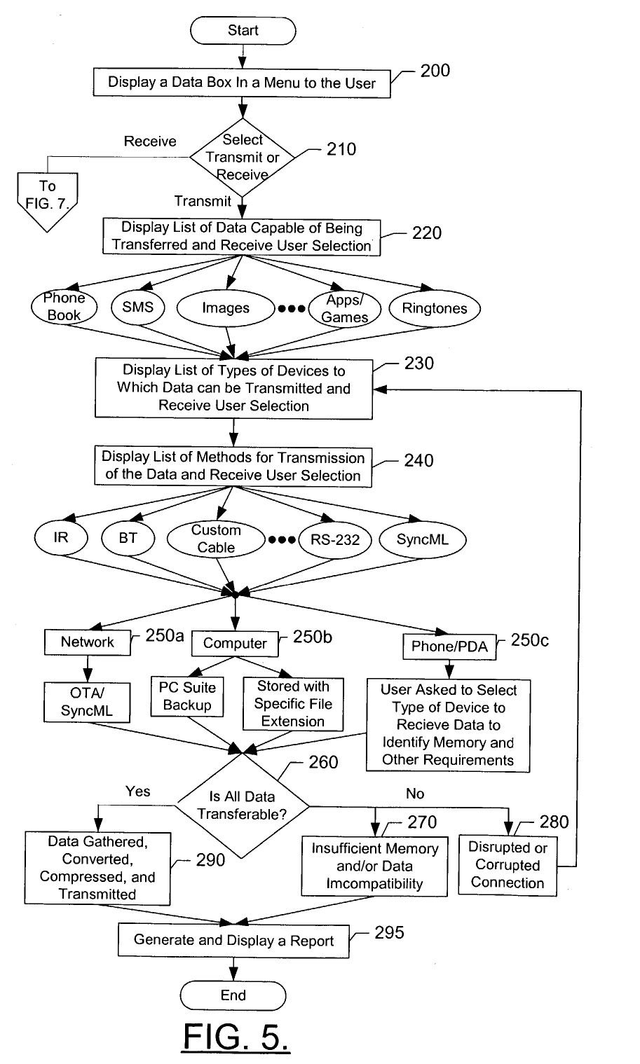

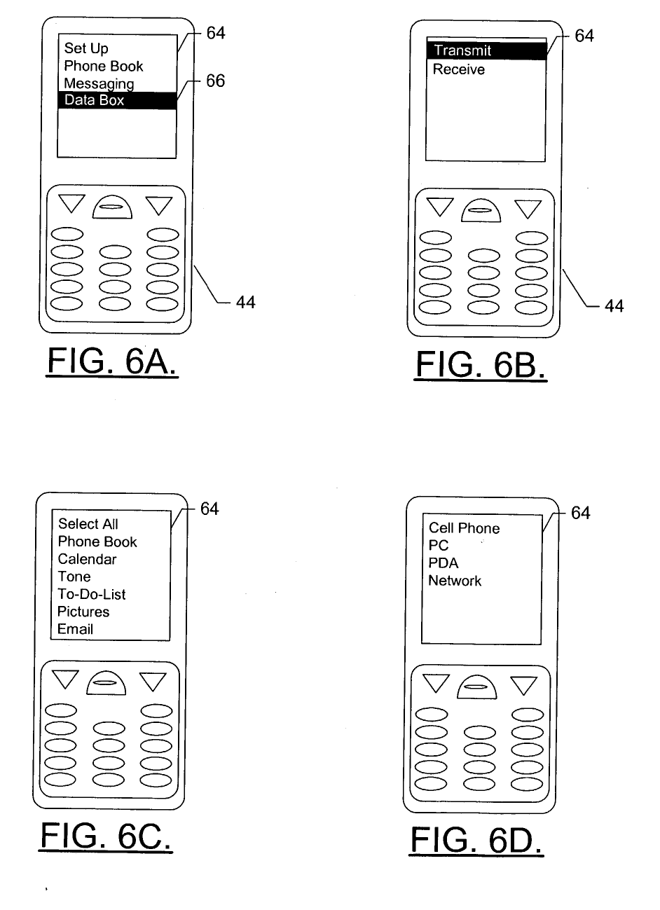

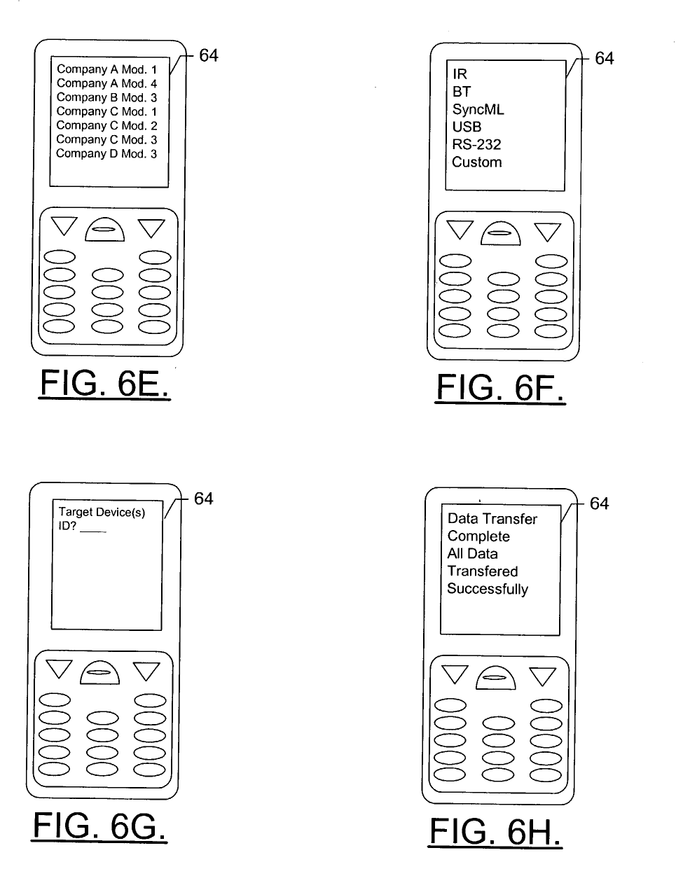

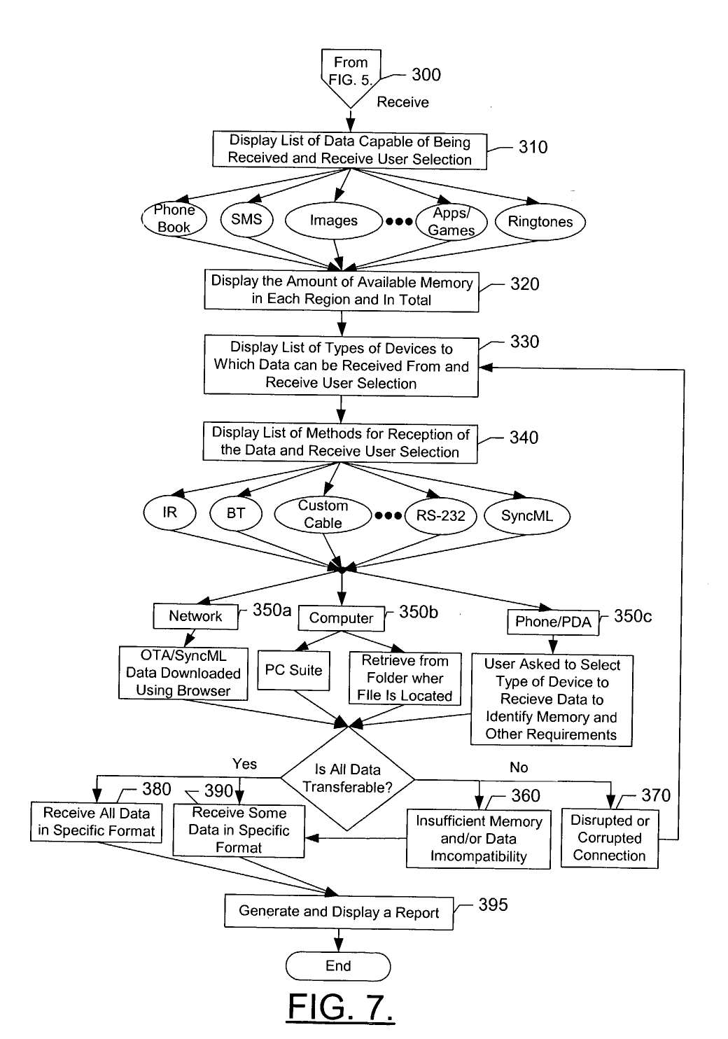

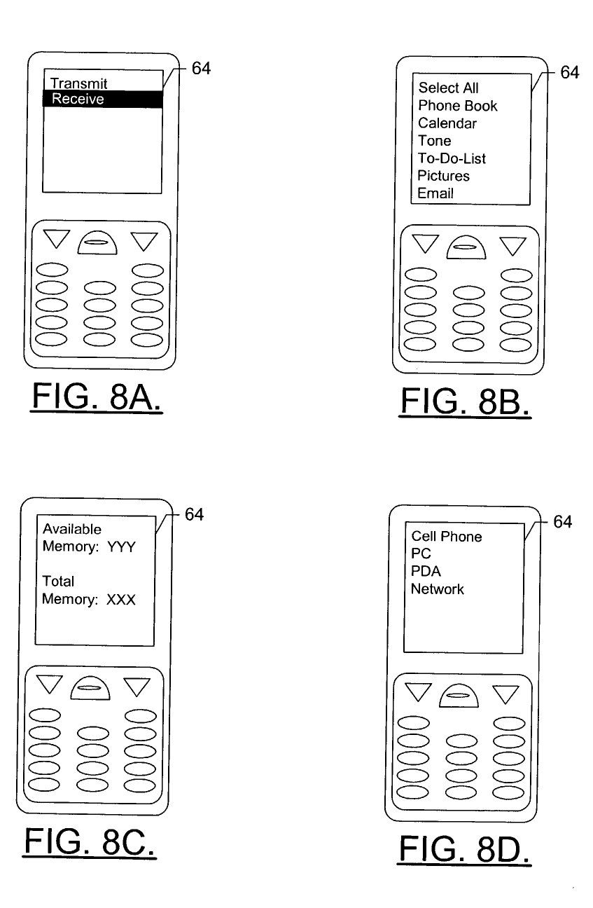

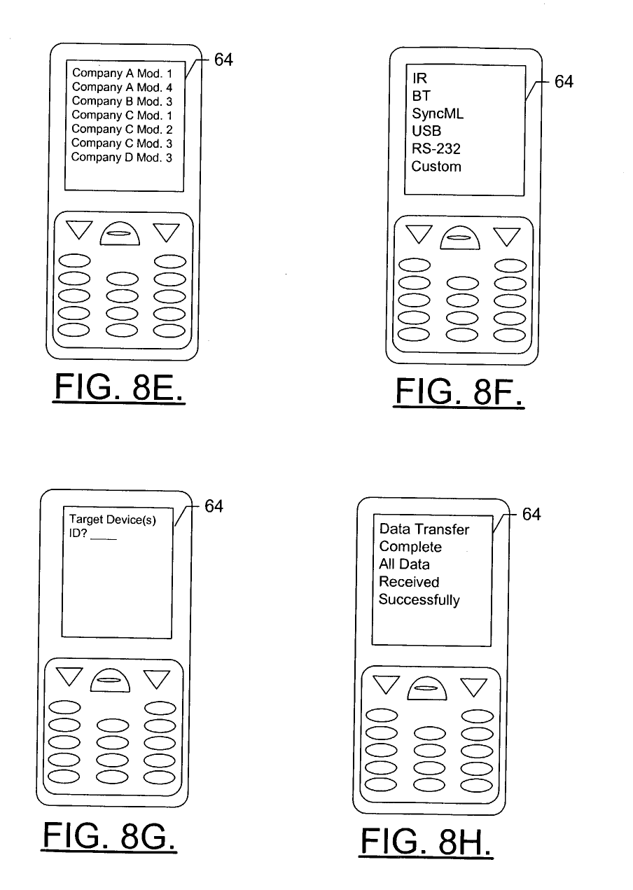

FIGS. 1 and 4 illustrate the general aspects of the systems and methods of the present invention with regard to transfer of data between different devices. FIGS. 5 and 6A-6H discussed later below provided added information concerning instances where the user selects to transmit data to another device, while FIGS. 7 and 8A-8H provide further detail with regard to instances where the user selects to receive data from another device.

With reference to FIGS. 1 and 4, in general, the systems and methods of the present invention initially provide a menu item on the feature list of the display related to transfer of data. The menu item can have any name that indicates to the user that the function associated with the menu item related to data transfer. In one embodiment, the systems and methods display a menu item entitled “Data Box” on the display 40. See block 100. If the Data Box is selected, the systems and methods next display a menu requesting the user to select either to transmit data to another device or receive data from another device. See block 110. After the user has selected whether to transmit or receive data, the systems and methods next displays a listing of data that is capable of being transferred. See block 120. This may include, for example, phonebook contacts, SMS, images, downloadable applications, downloadable ringtones, downloadable games, etc. Importantly, the menu includes a select all feature that allows the user to select all data for transfer.

After the user has selected data for transfer, the systems and methods of the present invention request from the user the type of device to which data is either transmitted to or received from, such as a cell phone, personal computer, personal digital assistant, network, etc. See block 130. In some embodiments, the systems and methods may further prompt the user to select a particular model for a device selected at block 130. See block 140. For example, if the user selected a cell phone, the system may further display a list of cell phone models to which data can be transferred to or received from.

With regard to compatibility of data, the systems and methods includes various software drivers that allow data to be transferred to different devices. For example, the systems and methods may include software drivers that allow the mobile station to communicate with a network, personal computer, cell phone, PDA, etc. It may also include individualized software driver for different models of a device. For example, the systems and methods may include various software drivers for communicating data with different cell phone models. These various drivers may be either stored in the device or downloadable.

After the user has selected the data and device, the systems and methods next prompt the user to select a method of transfer, such as IR, RF, Blue Tooth, etc. The selected method of transmission typically depends on the type of device selected to transmit data to or receive data from. For example, if the user has selected to transfer data to or from a network, the user will typically select an IR or RF type connection or use a cable connection. If the user has selected a mobile station, IR or RF connection will most likely be used. See block 150. The user may also be prompted to select the ID of the device selected to transmit data to or receive data from. See block 160. This step is not required when the user is using a cable connection or is using an IR or RF connection where the two devices are adjacent to each other. It may be required, however, where data is requested from a remote device, such as server or a remotely located mobile station.

The system and methods next retrieve the selected data for transfer. See block 170. If the user has selected to transmit data from the mobile station to another device, the data is retrieved from the mobile station. On the other hand, if the user has selected to receive data from another device, the systems and methods may either await reception of the data or they may instead send a command signal to the other device requesting transmission of the data.

If required, the data is first converted to a proper format using an appropriate software driver so that the data is compatible with the device to which it is being transferred. See block 180. This step is not required if the data is already in a compatible format. Next, the data is converted into a proper format for transmission, i.e., RF, IR, etc. See block 190. The data is then transferred and stored. See block 195.

FIGS. 1, 5, and 6A-6H illustrate in greater detail, the transmit functions of the present invention. In this embodiment, the systems and methods of the present invention initially provide a menu item on the features list of the display 40 of the mobile station or other device related to transfer and/or reception of data.

This is accomplished via software code operated on by the controller 32 to generate the display. Any nomenclature may be used to represent the data transfer/receive feature on the display. FIG. 6A illustrates a typical menu found on many mobile stations. The menu includes features available on most cell phones, such as set up, phone book, messaging, etc. As illustrated, the present invention provides an added item to the menu 64 entitled “Data Box” 66. This feature may be referred to herein as the “data box” feature, but may go by any name that indicates to the user that the function is used for transmission or reception of data. See FIG. 6A. (See block 200). With reference to FIG. 6B, when the data box is selected, the systems and methods display an option to the user of either “transmit” or “receive.”

With reference to FIG. 5, if the user selects transmit, see block 210, the systems and methods of the present invention next display a list of possible data that could be selected for transfer. See FIG. 6C and block 220. For example, the menu includes phone book, calendar, tone settings, to-do-list, pictures, email, voice recordings, SMS, downloadable applications, downloadable ringtones, downloadable games, etc. Importantly, the list also includes a “Select All” feature that allows the user to select all data for transmission.

After the user has selected data for transmission, the user next selects the location or device to which the data is to be transferred. See block 230 and FIG. 6D. The data may be transferred to a network, computer, other mobile station, such as a cell phone, PDA, etc. In each case, the network, computer, mobile station, etc. will have a means for receiving the data, (i.e., IR, RF, cable, etc.). For example, the mobile station may communicate with a network using a wireless RF connection such as Blue Tooth (BT), WiFi, etc. Similarly, a computer may include a wireless connection, such as IR or RF, and/or it may connect to the mobile station via a cable.

Based on the selection of device, the systems and methods of the present invention next display a list of all compatible models to which data can be transferred. For example, FIG. 6E illustrates and example, where the user has selected to transmit the data to another cell phone. In this instance, the systems and methods of the present invention display the various different models of cell phones to which the data may be transferred and allows the user to select the correct model. See block 250c. Although not illustrated, similar menus would be provided if the user selected to transmit the data to a network, PC, PDA, etc.

As illustrated in FIG. 5, when the selected device is a network, the data will be transmitted to the network and stored in a server or similar storage device associated with the network. The data is typically transmitted via OTA or SyncML. See block 250a. If the remote device is a computer, the systems and methods may communicate with the PC via PC Suite or similar software for transmitting and storing the data in the PC. See block 250b.

With regard to compatibility, in some instances, the data will not require conversion prior to transmission. For example, if the user is transferring the data from one mobile station to another mobile station that are of the same model, then the data typically will be compatible for both mobile stations. This may also be true for different models provided by the same manufacturer. However, there may instances where the data does require conversion before transmission to another mobile station, such as for example, when the two mobile stations are from different manufacturers and use different methods for data storage. In these instances, the systems and methods of the present invention further include software drivers stored in memory of the mobile station. The software drivers include code for converting data from a format associated with one mobile station into a format compatible for the second mobile station.

For example, for each telephone model listed in FIG. 6E that is not compatible with the user's cell phone, the systems and methods may include a software driver stored in memory, which is used to convert the data from the cell phone into a compatible format for transmission to the selected phone. In some instances, a conversion driver may not exist. In these instances, the systems and methods of the present invention will not transfer the data, but will instead, notify the user that the data is not compatible. Further, due to memory capacity, the mobile station may not include all possible conversion drivers. Instead, it may only include a subset of the most commonly used drivers. Thus, prior to data transmission, the user may be required to download the appropriate driver into the mobile station.

After the type of device has been selected, the systems and methods next display different methods for transferring the data, such as IR, Bluetooth (BT), synchronization markup language (SyncML), USB, RS-232, or some type of custom built cable and associated protocol. See FIG. 6F and block 240. The means for transmission of the data selected by the user will depend on the type of device and capabilities of the device to which the data is being transmitted.

With reference to FIGS. 5 and 6G, after the user has selected the form of data transmission, type of device, and the model of the device, the user may also need to provide the systems and methods with an identification of the device(s) to which the data is to be transferred. See FIG. 6G. This is typically not required if the user is transmitting the data using a cable, as the mobile stations will be physically linked to one another. Further, it is typically not required where IR is used, as the user will typically point the IR transducers of each mobile station at each other. However, in most RF transmission and some IR transmissions, the user will need to provide an ID for the mobile station to which the data is to be transferred. This may be the manufacturer ID, cell phone number, etc. that uniquely identifies the device.

With reference to FIG. 5, after the user has selected the data, method of transmission, and mobile station(s) to which the data it to be transmitted, the systems and methods of the present invention initially determine whether the selected data can be transferred. See block 260. The systems and methods determines whether the data is capable of being transmitted or whether their are restrictions on transfer of the data as set by the service provider or manufacturer. Further, the systems and methods access the available memory needed to transfer the data, as well as whether there is data compatibility. See block 270. It may also detect whether the connection between the two devices is faulty or is interrupted. See block 280.

If there is sufficient memory and the connection is not corrupted or disrupted, the systems and methods of the present invention retrieve the selected data from the memory of the mobile station, and use the appropriate software driver, if needed, to convert the data into the proper format for the mobile station selected for receiving the transmitted data. The system may also compress the data. The system next converts the data using the proper protocol for transmission based on that selected by the user. For example, if the user has selected IR for transmission, the data is converted using the proper IR protocol. Similarly, if the user selected BT, RS-232, etc., the data would be converted to the proper protocol.

With reference to FIG. 3A, after conversion, the data is then transmitted from the first mobile station 68 to at least one second mobile station 70. See block 290. When received at the second mobile station 70, the data is converted using the transmission protocol and stored in memory. The data is thus made available for use in the second mobile station. The systems and methods of the present invention then generate a report concerning the transmission that outlines what was transmitted, as well as any errors that may have occurred during retrieval and/or transmission of the data. See block 295 and FIG. 6H.

While not required, the systems and methods of the present invention may compress the data prior to transmission for bandwidth efficiency. Further, the systems and methods may use error correction algorithms, encryption, and password protect for the data.

FIGS. 7 and 8A-8H illustrate the receive functions of the present invention. If the user selects receive, see block 300, the systems and methods of the present invention next display a list of possible data that could be selected for reception. See FIGS. 8A-8B and block 310. For example, the menu includes phone book, calendar, tone settings, to-do-list, pictures, email, voice recordings, SMS, downloadable applications, downloadable ringtones, downloadable games, etc. Importantly, the list also includes a “Select All” feature that allows the user to select all data for transmission.

After the user has selected data for reception, the systems and methods next display the amount of memory available for each storage region of the mobile station and the total available memory. See block 320 and FIG. 8C. The user is then prompted to select the type of device that the user would like to receive data from. See block 330 and FIG. 8D. The data may be transferred to a network, computer, other mobile station, such as a cell phone, PDA, etc. In each case, the network, computer, mobile station, etc. will have a means for receiving the data, (i.e., IR, RF, cable, etc.).

Based on the selection of device, the systems and methods of the present invention next display a list of all compatible models to which data can be transferred. For example, FIG. 8E illustrates and example, where the user has selected to transmit the data to another cell phone. In this instance, the systems and methods of the present invention display the various different models of cell phones to which the data may be transferred and allows the user to select the correct model. See block 350c.

As illustrated in FIG. 7, when the selected device is a network, the data will be transmitted to the network and store in a server or similar storage device associated with the network. The data is typically transmitted via OTA or SyncML. See block 350a. If the remote device is a computer, the systems and methods may communicate with the PC via PC Suite or similar software for transmitting and storing the data in the PC. See block 350b.

With regard to compatibility, in some instances, the data will not require conversion. For example, if the user is transferring the data from one mobile station to another mobile station that are of the same model, then the data typically will be compatible for both mobile stations. This may also be true for different models provided by the same manufacturer. However, there may instances where the data does require conversion, such as for example, when the two mobile stations are from different manufacturers and use different methods for data storage. In some instances, the data will be converted prior to transmission to the mobile station. However, the mobile station may include software drivers stored in the memory of the mobile station for converting data from the transmission device into a format associated with the mobile station.

For example, for each telephone model listed in FIG. 8E that is not compatible with the user's cell phone, the systems and methods may include a software driver stored in memory, which is used to convert the data from the cell phone into a compatible format for transmission to the selected phone. It is understood that the mobile station may not include drivers for all devices, in which case, the system will not list a driver for the device and may provide an incompatibility error to the user if such a device is chosen. The mobile station may have to download the appropriate driver before communicating with a specific device.

After the type of device has been selected, the systems and methods next display different methods for transferring the data, such as IR, Bluetooth (BT), synchronization markup language (SyncML), USB, RS-232, or some type of custom built cable and associated protocol. See FIG. 8F and block 340.

With reference to FIGS. 7 and 8G, after the user has selected the form of data transmission, type of device, and the model of the device, the user may also need to provide the systems and methods with an identification of the mobile station(s) from which the data is to be received. This is typically not required if the user is receiving the data using a cable, as the mobile stations will be physically linked to one another. Further, it is typically not required where IR is used, as the user will typically point the IR transducers of each mobile station at each other. However, in most RF transmission and some IR transmissions, the user will need to provide an ID for the mobile station from which the data is to be received. This may be the manufacturer ID, cell phone number, etc. that uniquely identifies the mobile station.

With reference to FIG. 7, after the user has selected the data, method of transmission, and device from which the data is being received, the systems and methods of the present invention initially determine whether the selected data can be stored based on memory storage capacity in the mobile station, as well as whether there is data compatibility. See block 360. It may also detect whether the connection between the two devices is faulty or is interrupted.

If there is sufficient memory and the connection is not corrupted or disrupted, the systems and methods of the present invention begin the process of receiving the data. See block 370. In some embodiments, the mobile station may send an initial signal to the remote device commanding the remote device to transmit the selected data. In other embodiments, this step is not required. If there is sufficient data storage capacity, the systems and methods may receive and store all of the transmitted data. See block 380. However, if there is insufficient capacity, the systems and methods may only store portions of the data. See block 390. If required, the systems and methods will convert the data to a proper format for data storage using the appropriate software driver.

After the data is received, it is stored in the proper memory locations. The systems and methods of the present invention then generate a report concerning the data transfer that outlines what data was received and stored, as well as any errors that may have occurred during reception and storing of the data. See block 395 and FIG. 8H.

The systems and methods of the present invention may be used in various ways to transmit and receive data between different devices. For example, the systems and method of the present invention may be used to transmit or receive all of a user's customized data to a new device, such as when the user is replacing their current device with a new model. It is noted here that in this embodiment, the device may be programmed to erase the data after it has been transmitted and stored in the new device.

In another embodiment, the systems and methods for information/data transfer will allow the end user to selectively choose the data/information to be deleted from the source mobile phone/device after successful transfer. Further, information/data that is subject to copyright can be automatically deleted, either with or without the end user having to select the specific information/data from the menu, from the source mobile phone/device upon successful transfer of such information/data. In the event the deletion is set to be automatic, the end user is notified and is presented with the option of not transferring said information/data, prior to the transfer of the copyrighted data/information.

Further, in some embodiments, the systems and methods may be used to synchronize data between two or more devices, such as between the user's cell phone and PDA. Additionally, the systems and methods may be used to transmit data between the devices of different users, such as transmission of data or features located in one mobile station that are desired by the user of a second mobile station, such as a specific phone number, ring tone, game, picture, email, etc.

Importantly, the systems and methods of the present invention facilitate transmission of data between different devices without the need for an intermediary interface. Specifically, the systems and methods of the present invention include the requisite hardware and software in the devices themselves needed for retrieval, formatting, transmission, reception, and storage of data. Further, the systems and methods of the present invention provide a dedicated menu that walks the user through the necessary steps for transmitting data to another device. Additionally, the systems and methods of the present invention allow the user to select what data is to be transmitted, as opposed to transmittal of all data each time.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for transferring data between devices comprising:
providing first and second devices, wherein one of said devices comprises at least one datum of interest from a plurality of datum;
displaying a first menu, wherein the menu includes a selection related to transfer of data;
receiving input from a user requesting the datum of interest for transfer;
transmitting the selected datum of interest from one device to the other; and
storing the datum of interest in the device to which the datum was transmitted.

2. A method according to claim 1, wherein said displaying step further comprises displaying a second menu listing different types of data that are available for transfer.

3. A method according to claim 2, wherein said displaying step displays a selection that allows a user to select all listed data types for transmission.

4. A method according to claim 1, wherein said displaying step further displays a third menu listing different types of communication media that can be used to transfer the datum of interest.

5. A method according to claim 1, wherein said displaying step further displays a fourth menu listing types of mobile stations to which the datum interest may be transferred to or from.

6. A method according to claim 1 further comprising retrieving the datum of interest from a data storage of one device, transferring the datum to the other device, and storing the datum of interest in a data storage of the device receiving the datum.

7. A method according to claim 1, wherein the first and second devices store the datum of interest using different protocols, wherein said method further comprises converting the datum of interest from the protocol used by one device to the protocol of the second device.

9. A method according to claim 1, wherein said transferring step comprises transferring the datum of interest by one of infrared and radio frequency.

10. A method according to claim 1, wherein said transferring step comprises transferring the datum of interest by a cable connected between the first and second devices.

11. A method according to claim 1, wherein said displaying step displays an indication when said transferring step has finished transferring the datum of interest and detailing what datum was transferred and any errors that may have occurred.

12. A method according to claim 1, wherein
said displaying step comprises displaying a first menu on the first devise that includes a selection related to transmission of datum from the first device;
receiving input from a user requesting the datum of interest for transmission;
transmitting the selected datum of interest from the first device to the second device; and
storing the datum of interest in the second device.

13. A method according to claim 1, wherein
said displaying step comprises displaying a first menu on the first devise that includes a selection related to reception of datum of interest stored in the second device;
receiving input from a user requesting the datum of interest for reception;
receiving the selected datum of interest from the second device; and
storing the datum of interest in the first device.

14. A method according to claim 13 further comprising transmitting a control signal to the second device requesting transmission of the datum of interest to the first device.

15. A system for transferring data between devices comprising:
first and second devices each comprising a display, a storage device, a user interface, at least one type of circuitry for transmission and reception of data, and a controller in communication with the display, storage device, and transmission circuitry, wherein said controller for at least one of said devices:
displays on the display a first menu, wherein the menu includes a selection related to transferring data;
receives from the user interface input from a user requesting transfer of the datum of interest; and
operates the transmission circuitry to transfer the selected datum of interest.

16. A system according to claim 15, wherein said controller displays a second menu on the display listing different types of data that are available for transfer.

17. A system according to claim 16, wherein said controller displays a selection that allows a user to select all listed data types for transfer.

18. A system according to claim 15, wherein said controller displays a third menu listing different types of communication media that can be used to transfer the datum of interest.

19. A system according to claim 15, wherein said controller further displays a fourth menu listing types of devices to or from which the datum interest may be transferred.

20. A system according to claim 15, wherein said controller retrieves the datum of interest from the storage device of one device, transfers the datum to the other device, and stores the datum of interest in a data storage of the device receiving the datum.

21. A system according to claim 15, wherein the first and second devices store the datum of interest using different protocols, wherein said controller converts the datum of interest from the protocol used by one device to the protocol of the other device.

22. A system according to claim 15, wherein said transmission circuitry is one of an infrared transmission circuit and a radio frequency transmission circuit.

23. A system according to claim 15, wherein said controller displays an indication when said controller has finished transferring the datum of interest and detailing what datum was transferred and any errors that may have occurred.

24. A system according to claim 15, wherein said controller displays a first menu on the first devise that includes a selection related to transmission of datum from the first device;
receives input from a user requesting the datum of interest for transmission; and
transmits the selected datum of interest from the first device to the second device.

25. A system according to claim 15, wherein said controller displays a first menu on the first devise that includes a selection related to reception of datum of interest stored in the second device;
receives input from a user requesting the datum of interest for reception;
receives the selected datum of interest from the second device; and
stores the datum of interest in the first device.

26. A system according to claim 25, wherein said controller transmits a control signal to the second device requesting transmission of the datum of interest to the first device.

27. A mobile station capable of transferring data to another device comprising:
a display;
a user interface;
at least one type of circuitry for transmission and reception of data; and
a controller in communication with the display, storage device, and transmission circuitry, wherein said controller:
displays on the display a first menu, wherein the menu includes a selection related to transferring data;
receives from the user interface input from a user requesting transfer of the datum of interest; and
operates the transmission and reception circuitry to transfer the selected datum of interest.

28. A mobile station according to claim 27, wherein said controller displays a second menu on the display listing different types of data that are available for transfer.

29. A mobile station according to claim 28, wherein said controller displays a selection that allows a user to select all listed data types for transfer.

30. A mobile station according to claim 27, wherein said controller displays a third menu listing different types of communication media that can be used to transfer the datum of interest.

31. A mobile station according to claim 27, wherein said controller further displays a fourth menu listing types of devices to or from which the datum interest may be transferred.

32. A mobile station according to claim 27, wherein said controller retrieves the datum of interest from the storage device of the mobile station and transfers the datum to the other device.

33. A mobile station according to claim 27, wherein the mobile station and the device store the datum of interest using different protocols, wherein said controller converts the datum of interest from one protocol to the other protocol.

34. A mobile station according to claim 27, wherein said transmission and reception circuitry is one of an infrared transmission circuit and a radio frequency transmission circuit.

35. A mobile station according to claim 27, wherein said controller displays a first menu on the display of the mobile station that includes a selection related to reception of datum of interest stored in the device;
receives input from a user requesting the datum of interest for reception;
receives the selected datum of interest from the device; and
stores the datum of interest in the storage device of the mobile station.

36. A mobile station according to claim 35, wherein said controller transmits a control signal to the device requesting transmission of the datum of interest to the mobile station.
